(19) United States
(12) Patent Application Publication
(10) Pub. No.: US 2015/0253980 A1
(43) Pub. Date: Sep. 10, 2015

(54) INFORMATION PROCESSING METHOD AND ELECTRONIC DEVICE

(71) Applicants: Lenovo (Beijing) Co., Ltd., Beijing (CN); Beijing Lenovo Software Ltd., Beijing (CN)

(72) Inventor: Yan DAI, Beijing (CN)

(73) Assignees: LENOVO (BEIJING) CO., LTD., Beijing (CN); BEIJING LENOVO SOFTWARE LTD., Beijing (CN)

(21) Appl. No.: 14/229,871

(22) Filed: Mar. 29, 2014

(30) Foreign Application Priority Data
Mar. 7, 2014 (CN) 201410083860.6

(51) Int. Cl. G06F 3/0488; G06F 3/0484; G06F 3/0481; G06F 3/041; G06F 1/16

(52) U.S. Cl. CPC G06F 3/04883; G06F 3/041; G06F 1/163; G06F 3/04812; G06F 3/04842; G06F 2203/04104

(57) ABSTRACT

The invention discloses an information processing method, the method including: obtaining by the first sensor a first movement input of a first operating body located on the side of the frame structural body and a second movement input of a second operating body located on the side of the frame structural body; determining whether the first movement input and the second movement input satisfy a predetermined condition, wherein the predetermined condition is that a movement direction of the first operating body and a movement direction of the second operating body are consistent with respect to the sensing area; generating a control instruction when the first movement input and the second movement input satisfy the predetermined condition; and controlling a display interface on the display screen in response to the control instruction.

The present application claims the priority of Chinese Patent Application No. 201410083860.6, entitled as “Information processing method and electronic device”, and filed with the Chinese Patent Office on Mar. 7, 2014, the contents of which are incorporated herein by reference in its entirety.

### FIELD OF THE INVENTION

The present invention relates to the field of wireless communications and in particular to an information processing method and an electronic device.

### BACKGROUND OF THE INVENTION

At present, multi-purpose smart watches including a touch screen have emerged in the market along with popularization of smart phones and touch screens. However due to the very small size of a smart watch, a user has to trigger an object (e.g., an icon) on a display unit by operating on a display touch screen of the smart watch. By way of an example where the user sets time-counting-down, the user has to set time-counting-down by firstly scrolling through an operation page of the smart watch to locate and click on a corresponding time-counting application to start the time-counting application and then set a point of time, where the point of time has to be set with the precision up to a minute and a second. All the operations have to be performed on the screen, and the user has to lift up his or her finger each time the minute or the second is set to thereby confirm whether there is an adjustment result satisfying a demand of the user. The complicated operations may result in low efficiency thereof.

Apparently, the operations on the smart watch requires both respective applications to be searched for across the small screen and a precise setting to be made on the touch screen, and furthermore the operations typically have to be performed on the display screen, thus tending to result in shielding. As such, an improper operation may tend to be performed and the efficiency of the operations by the user may tend to be degraded.

### SUMMARY OF THE INVENTION

In view of this, an object of the invention is to provide an information processing method and an electronic device so as to avoid or reduce an improper operation from occurring due to an overly small screen of the electronic device and to improve the operation efficiency of a user while guaranteeing an experience of use by the user.

An embodiment of the invention provides an information processing method, applicable to an electronic device including a frame structural body, a first display component and a first sensor, and the frame structural body includes a fixing structure capable of fixing the electronic device on an object; the first display component is fixed on the frame structural body, and the first display component includes a display screen; and the display screen is exposed through a first surface of the frame structural body, the first sensor is arranged inside the frame structural body, a sensing area of the first sensor is located on a side of the frame structural body, and the first surface intersects with the side, wherein the method includes:

obtaining by the first sensor a first movement input of a first operating body located on the side of the frame structural body and a second movement input of a second operating body located on the side of the frame structural body;

determining whether the first movement input and the second movement input satisfy a predetermined condition, wherein the predetermined condition is that a movement direction of the first operating body and a movement direction of the second operating body are consistent with respect to the sensing area;

generating a control instruction when the first movement input and the second movement input satisfy the predetermined condition; and

controlling a display interface on the display screen in response to the control instruction.

An embodiment of the invention provides an electronic device including a first display component and a first sensor, wherein:

the first sensor is arranged inside a frame structural body, and the frame structural body includes a fixing structure capable of fixing the electronic device on an object; and a sensing area of the first sensor is located on a side of the frame structural body;

the first display component is fixed on the frame structural body, and the first display component includes a display screen; and the display screen is exposed through a first surface of the frame structural body, and the first surface intersects with the side of the frame structural body; and

the electronic device further includes: an information processor configured to obtain by the first sensor a first movement input of a first operating body located on the side of the frame structural body and a second movement input of a second operating body located on the side of the frame structural body; to determine whether the first movement input and the second movement input satisfy a predetermined condition, wherein the predetermined condition is that a movement direction of the first operating body and a movement direction of the second operating body are consistent with respect to the sensing area; to generate a control instruction when the first movement input and the second movement input satisfy the predetermined condition; and to control a display interface on the display screen in response to the control instruction; and

the first sensor is configured to obtain the first movement input of the first operating body located on the side of the frame structural body and the second movement input of the second operating body located on the side of the frame structural body.

The information processing method and the electronic device according to the embodiments of the invention can enable a user to perform corresponding control on the electronic device without operating on the operation interface on the display screen of the electronic device, and as such, it is possible to avoid or reduce an improper operation from occurring due to the overly small screen of the electronic device and to improve the operation efficiency of the user while guaranteeing an experience of use by the user.

### BRIEF DESCRIPTION OF THE DRAWINGS

FIG. 1 is a first schematic flow chart of an information processing method according to an embodiment of the invention;

FIG. 2 is a first schematic diagram of an operation by a user according to an embodiment of the invention;

FIG. 3 is a second schematic flow chart of an information processing method according to an embodiment of the invention;

FIG. 4 is a second schematic diagram of an operation by a user according to an embodiment of the invention;

FIG. 5 is a first schematic structural diagram of constitution of an electronic device according to an embodiment of the invention;

FIG. 6 is a second schematic structural diagram of constitution of an electronic device according to an embodiment of the invention; and

FIG. 7 is a schematic structural diagram of an appearance of an electronic device according to an embodiment of the invention.

### DETAILED DESCRIPTION OF THE INVENTION

The invention will be further detailed below with reference to the drawings and particular embodiments thereof.

### First Embodiment

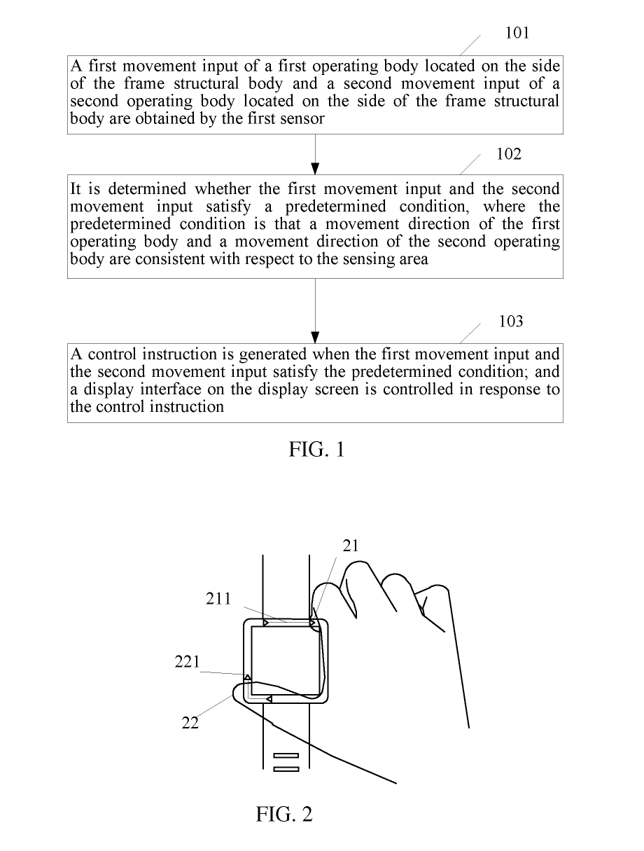

An embodiment of the invention provides an information processing method, applicable to an electronic device including a frame structural body, a first display component and a first sensor, and the frame structural body includes a fixing structure capable of fixing the electronic device on an object; the first display component is fixed on the frame structural body, and the first display component includes a display screen; and the display screen is exposed through a first surface of the frame structural body, the first sensor is arranged inside the frame structural body, a sensing area of the first sensor is located on a side of the frame structural body, and the first surface intersects with the side, the electronic device is, for example, a smart watch; and as illustrated in FIG. 1, the method includes:

Step 101: A first movement input of a first operating body located on the side of the frame structural body and a second movement input of a second operating body located on the side of the frame structural body are obtained by the first sensor;

Step 102: It is determined whether the first movement input and the second movement input satisfy a predetermined condition, where the predetermined condition is that a movement direction of the first operating body and a movement direction of the second operating body are consistent with respect to the sensing area; and

Step 103: A control instruction is generated when the first movement input and the second movement input satisfy the predetermined condition; and a display interface on the display screen is controlled in response to the control instruction.

The foregoing electronic device can be a smart watch. The frame structural body can be a dial; and the first display component is a display component installed on the frame structural body, and the display component can include the display screen of the smart watch.

The sensing area of the first sensor can be located on the side of the frame structural body as follows: when the frame structural body is a polygon, e.g., a rectangle, the sensing area is located on respective edges of the frame structural body, e.g., four edges of the rectangle; and when the frame structural body is a circle, the sensing area is located on the side of the frame structural body.

Preferably the first movement input of the first operating body located on the side of the frame structural body and the second movement input of the second operating body located on the side of the frame structural body can be obtained by the first sensor as follows: a user in need of an operation on the smart watch starts to perform a movement operation by using two fingers respectively at any locations on the side of the frame structural body;

Where whether a movement operation has been performed by the fingers can be determined by determining that a movement operation has been performed by the fingers if the fingers have moved over a distance above a preset distance threshold.

It can be determined whether the movement direction of the first operating body and the movement direction of the second operating body are consistent with respect to the sensing area by determining whether both the movement direction of the first operating body and the movement direction of the second operating body are clockwise, or counterclockwise with respect to the sensing area, for example, as illustrated in FIG. 2, where the user moving the two fingers clockwise respectively on the side of the dial can indicate that they have a consistent movement direction with respect to the sensing area.

The display interface on the display screen can be controlled in response to the control instruction by the smart watch, which generates the corresponding control instruction for the operation by the fingers of the user according to a preset rule upon detecting that the operation satisfies the predetermined condition.

As can be apparent, with the foregoing solution, the user can perform corresponding control on the electronic device without operating on the operation interface of the electronic device, and as such it is possible to avoid or reduce an improper operation from occurring due to the overly small screen of the electronic device and to improve the operation efficiency of the user while guaranteeing an experience of use by the user.

### Second Embodiment

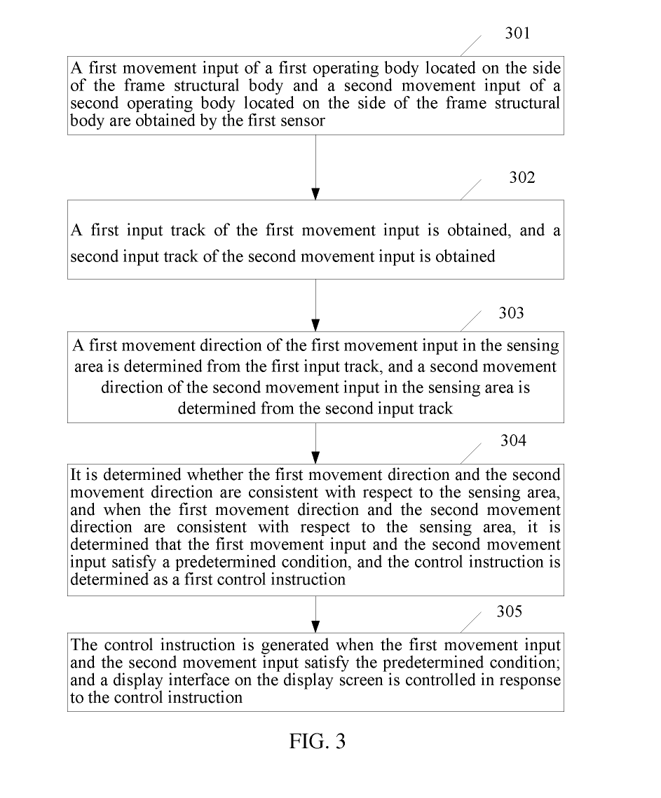

An embodiment of the invention provides an information processing method, applicable to an electronic device including a frame structural body, a first display component and a first sensor, and the frame structural body includes a fixing structure capable of fixing the electronic device on an object; the first display component is fixed on the frame structural body, and the first display component includes a display screen; and the display screen is exposed through a first surface of the frame structural body, the first sensor is arranged inside the frame structural body, a sensing area of the first sensor is located on a side of the frame structural body, and the first surface intersects with the side, electronic device is, for example, a smart watch; and as illustrated in FIG. 3, the method includes:

Step 301: A first movement input of a first operating body located on the side of the frame structural body and a second movement input of a second operating body located on the side of the frame structural body are obtained by the first sensor;

Step 302: A first input track of the first movement input is obtained, and a second input track of the second movement input is obtained;

Step 303: A first movement direction of the first movement input in the sensing area is determined from the first input track, and a second movement direction of the second movement input in the sensing area is determined from the second input track;

Step 304: It is determined whether the first movement direction and the second movement direction are consistent with respect to the sensing area, and when the first movement direction and the second movement direction are consistent with respect to the sensing area, it is determined that the first movement input and the second movement input satisfy a predetermined condition, and the control instruction is determined as a first control instruction; and

Step 305: The control instruction is generated when the first movement input and the second movement input satisfy the predetermined condition; and a display interface on the display screen is controlled in response to the control instruction.

The foregoing electronic device can be a smart watch. The frame structural body can be a dial; and the first display component is a display component installed on the frame structural body, and the display component can include the display screen of the smart watch.

The sensing area of the first sensor can be located on the side of the frame structural body as follows: when the frame structural body is a polygon, e.g., a rectangle, the sensing area is located on respective edges of the frame structural body, e.g., four edges of the rectangle; and when the frame structural body is a circle, the sensing area is located on the side of the frame structural body.

Preferably the first movement input of the first operating body located on the side of the frame structural body and the second movement input of the second operating body located on the side of the frame structural body can be obtained by the first sensor as follows: a user in need of an operation on the smart watch starts to perform a movement operation by using two fingers respectively at any locations on the side of the frame structural body;

Where whether a movement operation has been performed by the fingers can be determined by determining that a movement operation has been performed by the fingers if the fingers have moved over a distance above a preset distance threshold.

It can be determined whether the movement direction of the first operating body and the movement direction of the second operating body are consistent with respect to the sensing area by determining whether both the movement direction of the first operating body and the movement direction of the second operating body are clockwise or counterclockwise with respect to the sensing area, for example, as illustrated in FIG. 2, where the user moving the two fingers clockwise respectively on the side of the dial can indicate that they have a consistent movement direction with respect to the sensing area.

The first input track of the first movement input and the second input track of the second movement input can be obtained respectively by determining the first input track corresponding to the first movement input from starting coordinates, track coordinates and ending coordinates corresponding to the first movement input and determining the second input track corresponding to the second movement input from starting coordinates, track coordinates and ending coordinates corresponding to the second movement input, for example, as illustrated in FIG. 2, where the user moves the two fingers clockwise, and then track coordinates across which the user moves the two fingers are obtained respectively, and input tracks of the two fingers are determined from the track coordinates corresponding to the two fingers.

The first movement direction of the first movement input in the sensing area can be determined from the first input track and the second movement direction of the second movement input in the sensing area can be determined from the second input track by: determining the movement direction of the first movement input in the sensing area from the starting coordinates and the ending coordinates of the first input track and determining the movement direction of the second movement input in the sensing area from the starting coordinates and the ending coordinates of the second input track, for example, as illustrated in FIG. 2, where a movement track 211 of an index finger 21 of the user is detected, and a first movement direction of the index finger 21 is determined from starting coordinates and ending coordinates of the movement track 211 as from the left to the right, i.e., clockwise; and a movement track 221 of a thumb 22 of the user is detected, and a second movement direction of the thumb 22 is determined from starting coordinates and ending coordinates of the movement track 221 as from the right to the left, i.e., counterclockwise.

The display interface on the display screen can be controlled in response to the control instruction by the smart watch, which generates the corresponding control instruction on the operation by the fingers of the user according to a preset rule upon detecting that the operation satisfies the predetermined condition.

As can be apparent, with the foregoing solution, the user can perform corresponding control on the electronic device without operating on the operation interface of the electronic device, and as such it is possible to avoid or reduce an improper operation from occurring due to the overly small screen of the electronic device and to improve the operation efficiency of the user while guaranteeing an experience of use by the user.

### Third Embodiment

An embodiment of the invention provides an information processing method, applicable to an electronic device including a frame structural body, a first display component and a first sensor, and the frame structural body includes a fixing structure capable of fixing the electronic device on an object; the first display component is fixed on the frame structural body, and the first display component includes a display screen; and the display screen is exposed through a first surface of the frame structural body, the first sensor is arranged inside the frame structural body, a sensing area of the first sensor is located on a side of the frame structural body, and the first surface intersects with the side, electronic device is, for example, a smart watch; and as illustrated in FIG. 3, the method includes:

Step 301: A first movement input of a first operating body located on the side of the frame structural body and a second movement input of a second operating body located on the side of the frame structural body are obtained by the first sensor;

Step 302: A first input track of the first movement input is obtained, and a second input track of the second movement input is obtained;

Step 303: A first movement direction of the first movement input in the sensing area is determined from the first input track, and a second movement direction of the second movement input in the sensing area is determined from the second input track;

Step 304: It is determined whether the first movement direction and the second movement direction are consistent with respect to the sensing area, and when the first movement direction and the second movement direction are consistent with respect to the sensing area, it is determined that the first movement input and the second movement input satisfy a predetermined condition, and the control instruction is determined as a first control instruction; and

Step 305: The control instruction is generated when the first movement input and the second movement input satisfy the predetermined condition; and a display interface on the display screen is controlled in response to the control instruction.

The foregoing electronic device can be a smart watch. The frame structural body can be a dial; and the first display component is a display component installed on the frame structural body, and the display component can include the display screen of the smart watch.

The sensing area of the first sensor can be located on the side of the frame structural body as follows: when the frame structural body is a polygon, e.g., a rectangle, the sensing area is located on respective edges of the frame structural body, e.g., four edges of the rectangle; and when the frame structural body is a circle, the sensing area is located on the side of the frame structural body.

Preferably the first movement input of the first operating body located on the side of the frame structural body and the second movement input of the second operating body located on the side of the frame structural body can be obtained by the first sensor as follows: a user in need of an operation on the smart watch starts to perform a movement operation by using two fingers respectively at any locations on the side of the frame structural body;

Where whether a movement operation has been performed by the fingers can be determined by determining that a movement operation has been performed by the fingers if the fingers have moved over a distance above a preset distance threshold.

It can be determined whether the movement direction of the first operating body and the movement direction of the second operating body are consistent with respect to the sensing area by determining whether both the movement direction of the first operating body and the movement direction of the second operating body are clockwise or time-counterclockwise with respect to the sensing area, for example, as illustrated in FIG. 2, where the user moving the two fingers clockwise respectively on the side of the dial can indicate that they have a consistent movement direction with respect to the sensing area.

Preferably the first input track of the first movement input and the second input track of the second movement input can be obtained respectively by determining the first input track corresponding to the first movement input from starting coordinates, track coordinates and ending coordinates corresponding to the first movement input and determining the second input track corresponding to the second movement input from starting coordinates, track coordinates and ending coordinates corresponding to the second movement input, for example, as illustrated in FIG. 2, the user moves the two fingers clockwise, and then track coordinates across which the user moves the two fingers are obtained respectively, and input tracks of the two fingers are determined from the track coordinates corresponding to the two fingers.

The first movement direction of the first movement input in the sensing area can be determined from the first input track and the second movement direction of the second movement input in the sensing area can be determined from the second input track by: determining the movement direction of the first movement input in the sensing area from the starting coordinates and the ending coordinates of the first input track and determining the movement direction of the second movement input in the sensing area from the starting coordinates and the ending coordinates of the second input track, for example, as illustrated in FIG. 2, where a movement track 211 of an index finger 21 of the user is detected, and a first movement direction of the index finger 21 is determined from starting coordinates and ending coordinates of the movement track 211 as from the left to the right, i.e., clockwise;

and a movement track 221 of a thumb 22 of the user is detected, and a second movement direction of the thumb 22 is determined from starting coordinates and ending coordinates of the movement track 221 as from the right to the left, i.e., counterclockwise.

The display interface on the display screen can be controlled in response to the control instruction by the smart watch, which generates the corresponding control instruction on the operation by the fingers of the user according to a preset rule upon detecting that the operation satisfies the predetermined condition.

The first control instruction can be a first rotation instruction or a second rotation instruction or a third rotation instruction.

The first control instruction and the response thereto will be described below respectively.

When the first control instruction is the first rotation instruction, the display interface on the display screen can be controlled in response to the control instruction by rotating the display interface along the first input track and in the movement direction thereof in response to the first rotation instruction, for example, when there is a map displayed in the display interface, the first rotation instruction is obtained, and at this time the smart watch moves the map in the movement direction of the first input track, and it is assumed that the first input track is the movement track 211 of the index finger 21 as illustrated in FIG. 2, the map will be moved rightward along the movement track 211 of the index finger 21; or

When the first control instruction is the first rotation instruction, the display interface on the display screen can be controlled in response to the control instruction by rotating the display interface along the second input track and in the movement direction thereof in response to the first rotation instruction, for example, when there is a map displayed in the display interface, the first rotation instruction is obtained, and at this time the smart watch moves the map in the movement direction of the first input track, and it is assumed that the first input track is the movement track 221 of the thumb 22 as illustrated in FIG. 2, the map will be moved leftward along the movement track 221 of the thumb 22.

When the first control instruction is the second rotation instruction, the display interface on the display screen can be controlled in response to the control instruction by controlling a selection box to move along the first input track and in the movement direction thereof to select a first object on the display interface in response to the second rotation instruction, for example, when there is an operation box displayed in the display interface, the operation box can be a cursor for a time-counting operation, and when the second rotation instruction is obtained, the smart watch moves the cursor for a time-counting operation in the movement direction of the first input track and over the movement distance of the first input track until the cursor is moved to a specific scale which is taken as the first object, and it is assumed that the first input track is the movement track 211 of the index finger 21 as illustrated in FIG. 2, the cursor for a time-counting operation will be moved rightward along the movement track 211 of the index finger 21 over a corresponding distance until the cursor is stopped at the location of the first object selected on the display interface; or

When the first control instruction is the second rotation instruction, the display interface on the display screen can be controlled in response to the control instruction by controlling a selection box to move along the second input track and in the movement direction thereof to select a first object on the display interface in response to the second rotation instruction, for example, when there is an operation box displayed in the display interface, the operation box can be a cursor for a time-counting operation, and when the second rotation instruction is obtained, the smart watch moves the cursor for a time-counting operation in the movement direction of the second input track and over the movement distance of the second input track until the cursor is moved to a specific scale which is taken as the first object, and it is assumed that the second input track is the movement track 211 of the index finger 21 as illustrated in FIG. 2, the cursor for a time-counting operation will be moved rightward along the movement track 211 of the index finger 21 over a corresponding distance until the cursor is stopped at the location of the first object selected on the display interface.

When the control instruction is the third rotation instruction, the display interface on the display screen can be controlled in response to the control instruction as follows: a second sensor detects a third operation and selects a second object on the display interface in response to the third operation; and changes the location of the second object along the first input track and in the movement direction thereof in response to the third rotation instruction, where the second sensor can be installed above the display screen of the electronic device, for example, when the user performs a time-counting operation which needs to select a specific scale using a cursor, the user can firstly adjust the cursor to the scale and then touch the second sensor using his or her middle finger, and the second sensor can take the touch operation as the third operation and determine from the third operation that the user has selected the time scale; and then change both the cursor and its selected time scale according to the first input track and in the movement direction thereof or change both the cursor and its selected time scale along the second input track and in the movement direction thereof, in response to the third rotation instruction.

As can be apparent, with the foregoing solution, the user can perform selection, time-counting and other control on the electronic device without operating on the operation interface of the electronic device, and as such it is possible to avoid or reduce an improper operation from occurring due to the overly small screen of the electronic device and to improve the operation efficiency of the user while guaranteeing an experience of use by the user.

### Fourth Embodiment

An embodiment of the invention provides an information processing method, applicable to an electronic device including a frame structural body, a first display component and a first sensor, and the frame structural body includes a fixing structure capable of fixing the electronic device on an object; the first display component is fixed on the frame structural body, and the first display component includes a display screen; and the display screen is exposed through a first surface of the frame structural body, the first sensor is arranged inside the frame structural body, a sensing area of the first sensor is located on a side of the frame structural body, and the first surface intersects with the side, the electronic device is, for example, a smart watch; and as illustrated in FIG. 3, the method includes:

Step 301: a first movement input of a first operating body located on the side of the frame structural body and a second movement input of a second operating body located on the side of the frame structural body are obtained by the first sensor;

Step 302: a first input track of the first movement input is obtained, and a second input track of the second movement input is obtained;

Step 303: a first movement direction of the first movement input in the sensing area is determined from the first input track, and a second movement direction of the second movement input in the sensing area is determined from the second input track;

Step 304: it is determined whether the first movement direction and the second movement direction are consistent with respect to the sensing area, and when the first movement direction and the second movement direction are consistent with respect to the sensing area, it is determined that the first movement input and the second movement input satisfy a predetermined condition, and the control instruction is determined as a first control instruction; and

Step 305: The control instruction is generated when the first movement input and the second movement input satisfy the predetermined condition; and a display interface on the display screen is controlled in response to the control instruction.

The foregoing electronic device can be a smart watch. The frame structural body can be a dial; and the first display component is a display component installed on the frame structural body, and the display component can include the display screen of the smart watch.

The sensing area of the first sensor can be located on the side of the frame structural body as follows: when the frame structural body is a polygon, e.g., a rectangle, the sensing area is located on respective edges of the frame structural body, e.g., four edges of the rectangle; and when the frame structural body is a circle, the sensing area is located on the side of the frame structural body.

Preferably the first movement input of the first operating body located on the side of the frame structural body and the second movement input of the second operating body located on the side of the frame structural body can be obtained by the first sensor as follows: a user in need of an operation on the smart watch starts to perform a movement operation by using two fingers respectively at any locations on the side of the frame structural body;

Where whether a movement operation has been performed by the fingers can be determined by determining that a movement operation has been performed by the fingers if the fingers have moved over a distance above a preset distance threshold.

It can be determined whether the movement direction of the first operating body and the movement direction of the second operating body are consistent with respect to the sensing area by determining whether both the movement direction of the first operating body and the movement direction of the second operating body are clockwise or time-counterclockwise with respect to the sensing area, for example, as illustrated in FIG. 2, where the user moving the two fingers clockwise respectively on the side of the dial can indicate that they have a consistent movement direction with respect to the sensing area.

Preferably the first input track of the first movement input and the second input track of the second movement input can be obtained respectively by determining the first input track corresponding to the first movement input from starting coordinates, track coordinates and ending coordinates corresponding to the first movement input and determining the second input track corresponding to the second movement input from starting coordinates, track coordinates and ending coordinates corresponding to the second movement input, for example, as illustrated in FIG. 2, where the user moves the two fingers clockwise, and then track coordinates across which the user moves the two fingers are obtained respectively, and input tracks of the two fingers are determined from the track coordinates corresponding to the two fingers.

The first movement direction of the first movement input in the sensing area can be determined from the first input track and the second movement direction of the second movement input in the sensing area can be determined from the second input track by: determining the movement direction of the first movement input in the sensing area from the starting coordinates and the ending coordinates of the first input track and determining the movement direction of the second movement input in the sensing area from the starting coordinates and the ending coordinates of the second input track, for example, as illustrated in FIG. 2, where a movement track 211 of an index finger 21 of the user is detected, and a first movement direction of the index finger 21 is determined from starting coordinates and ending coordinates of the movement track 211 as from the left to the right, i.e., clockwise;

and a movement track 221 of a thumb 22 of the user is detected, and a second movement direction of the thumb 22 is determined from starting coordinates and ending coordinates of the movement track 221 as from the right to the left, i.e., counterclockwise.

The display interface on the display screen can be controlled in response to the control instruction by the smart watch which generates the corresponding control instruction on the operation by the fingers of the user according to a preset rule upon detecting that the operation satisfies the predetermined condition.

The first control instruction can be a first rotation instruction or a second rotation instruction or a third rotation instruction.

The first control instruction and the response thereto will be described below respectively.

When the first control instruction is the first rotation instruction, the display interface on the display screen can be controlled in response to the control instruction by rotating the display interface along the first input track and in the movement direction thereof in response to the first rotation instruction, for example, when there is a map displayed in the display interface, the first rotation instruction is obtained, and at this time the smart watch moves the map in the movement direction of the first input track, and it is assumed that the first input track is the movement track 211 of the index finger 21 as illustrated in FIG. 2, the map will be moved rightward along with the movement track 211 of the index finger 21; or

When the first control instruction is the first rotation instruction, the display interface on the display screen can be controlled in response to the control instruction by: rotating the display interface along the second input track and in the movement direction thereof in response to the first rotation instruction, for example, when there is a map displayed in the display interface, the first rotation instruction is obtained, and at this time the smart watch moves the map in the movement direction of the first input track, and it is assumed that the first input track is the movement track 221 of the thumb 22 as illustrated in FIG. 2, the map will be moved leftward along with the movement track 221 of the thumb 22.

When the first control instruction is the second rotation instruction, the display interface on the display screen can be controlled in response to the control instruction by controlling a selection box to move along the first input track and in the movement direction thereof to select a first object on the display interface in response to the second rotation instruction, for example, when there is an operation box displayed in the display interface, the operation box can be a cursor for a time-counting operation, and when the second rotation instruction is obtained, the smart watch moves the cursor for a time-counting operation in the movement direction of the first input track and over the movement distance of the first input track until the cursor is moved to a specific scale which is taken as the first object, and it is assumed that the first input track is the movement track 211 of the index finger 21 as illustrated in FIG. 2, the cursor for a time-counting operation will be moved rightward along the movement track 211 of the index finger 21 over a corresponding distance until the cursor is stopped at the location of the first object selected on the display interface; or

When the first control instruction is the second rotation instruction, the display interface on the display screen can be controlled in response to the control instruction by controlling a selection box to move along the second input track and in the movement direction thereof to select a first object on the display interface in response to the second rotation instruction, for example, when there is an operation box displayed in the display interface, the operation box can be a cursor for a time-counting operation, and when the second rotation instruction is obtained, the smart watch moves the cursor for a time-counting operation in the movement direction of the second input track and over the movement distance of the second input track until the cursor is moved to a specific scale which is taken as the first object, and it is assumed that the second input track is the movement track 211 of the index finger 21 as illustrated in FIG. 2, the cursor for a time-counting operation will be moved rightward along the movement track 211 of the index finger 21 over a corresponding distance until the cursor is stopped at the location of the first object selected on the display interface.

When the control instruction is the third rotation instruction, the display interface on the display screen can be controlled in response to the control instruction as follows: a second sensor detects a third operation and selects a second object on the display interface in response to the third operation; and changes the location of the second object along the first input track and in the movement direction thereof in response to the third rotation instruction, where the second sensor can be installed above the display screen of the electronic device, for example, when the user performing a time-counting operation needs to select a specific scale using a cursor, the user can firstly adjust the cursor to the scale and then touch the second sensor using his or her middle finger, and the second sensor takes the touch operation as the third operation and determines from the third operation that the user has selected the time scale; and then change both the cursor and its selected time scale along the first input track and in the movement direction thereof or change both the cursor and its selected time scale along the second input track and in the movement direction thereof in response to the third rotation instruction.

Furthermore after it is determined whether the first movement direction and the second movement direction are consistent with respect to the sensing area, the method further includes: when the first movement direction and the second movement direction are not consistent with respect to the sensing area, the control instruction is determined as a second control instruction, where when the first movement direction and the second movement direction are not consistent, it may be that both of the two fingers are moved to the center of the watch, and at this time the first movement direction and the second movement direction are not consistent with respect to the sensing area.

The second control instruction can be a closing instruction to close an interface of a current application; or can be a back-to-home-interface instruction to go from an interface of a current application back to a home interface, where the closing instruction is to close the interface displayed by the current application, and an interface at the next higher level can be displayed after the interface is closed.

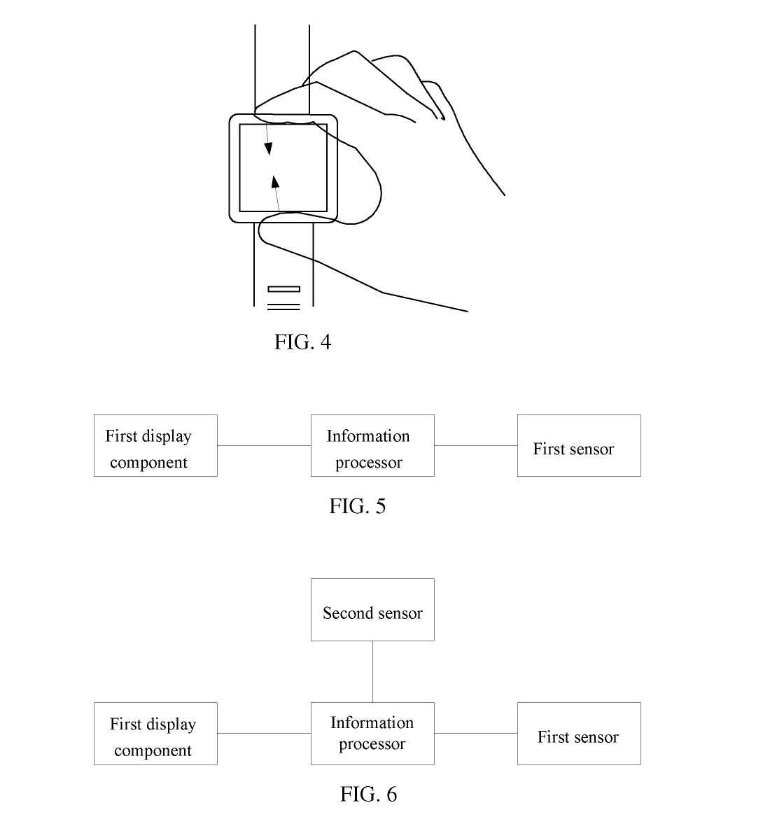

For example, when the user having finished the foregoing time-counting operation wants to close the operation, the user can move the two fingers to the center of the dial, as illustrated in FIG. 4, and at this time the user can be returned to an operation interface at the next higher level or directly to a home interface.

As can be apparent, with the foregoing solution, the user can perform selection, time-counting and other control on the electronic device without operating on the operation interface of the electronic device, and as such it is possible to avoid or reduce an improper operation from occurring due to the overly small screen of the electronic device and to improve the operation efficiency of the user while guaranteeing an experience of use by the user.

### Fifth Embodiment

An embodiment of the invention further provides an electronic device, as illustrated in FIG. 5, and the electronic device includes a first display component and a first sensor, where:

The first sensor is arranged inside a frame structural body, and the frame structural body includes a fixing structure capable of fixing the electronic device on an object; and a sensing area of the first sensor is located on a side of the frame structural body;

The first display component is fixed on the frame structural body, and the first display component includes a display screen; and the display screen is exposed through a first surface of the frame structural body, and the first surface intersects with the side of the frame structural body; and

The electronic device further includes: an information processor configured to obtain by the first sensor a first movement input of a first operating body located on the side of the frame structural body and a second movement input of a second operating body located on the side of the frame structural body; to determine whether the first movement input and the second movement input satisfy a predetermined condition, where the predetermined condition is that a movement direction of the first operating body and a movement direction of the second operating body are consistent with respect to the sensing area; to generate a control instruction when the first movement input and the second movement input satisfy the predetermined condition; and to control a display interface on the display screen in response to the control instruction; and

The first sensor is configured to obtain the first movement input of the first operating body located on the side of the frame structural body and the second movement input of the second operating body located on the side of the frame structural body.

The foregoing electronic device can be a smart watch. The frame structural body can be a dial; and the first display component is a display component installed on the frame structural body, and the display component can include the display screen of the smart watch.

When the frame structural body is a polygon, e.g., a rectangle, the sensing area is located on respective edges of the frame structural body, e.g., four edges of the rectangle; and when the frame structural body is a circle, the sensing area is located on the side of the frame structural body.

Preferably the first movement input of the first operating body located on the side of the frame structural body and the second movement input of the second operating body located on the side of the frame structural body can be obtained by the first sensor as follows: a user in need of an operation on the smart watch starts to perform a movement operation by using two fingers respectively at any locations on the side of the frame structural body; where whether a movement operation has been performed by the fingers can be determined by determining that a movement operation has been performed by the fingers if the fingers have moved over a distance above a preset distance threshold.

The information processor is further configured to determine whether both the movement direction of the first operating body and the movement direction of the second operating body are clockwise or counterclockwise with respect to the sensing area, for example, as illustrated in FIG. 2, where the user moving the two fingers clockwise respectively on the side of the dial can indicate that they have a consistent movement direction with respect to the sensing area.

The display interface on the display screen can be controlled in response to the control instruction by the smart watch which generates the corresponding control instruction on the operation by the fingers of the user according to a preset rule upon detecting that the operation satisfies the predetermined condition.

As can be apparent, with the foregoing solution, the user can perform corresponding control on the electronic device without operating on the operation interface of the electronic device, and as such it is possible to avoid or reduce an improper operation from occurring due to the overly small screen of the electronic device and to improve the operation efficiency of the user while guaranteeing an experience of use by the user.

### Sixth Embodiment

An embodiment of the invention further provides an electronic device, as illustrated in FIG. 6, and the electronic device includes a first display component and a first sensor, where:

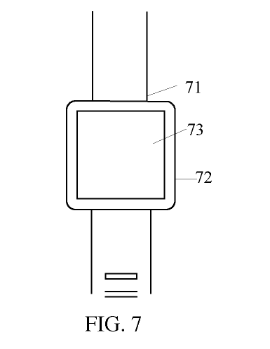

The first sensor is arranged inside a frame structural body, as illustrated in FIG. 7, and the frame structural body 71 includes a fixing structure capable of fixing the electronic device on an object, e.g., a watch band; and a sensing area of the first sensor is located on a side 72 of the frame structural body;

The first display component 73 is fixed on the frame structural body, and the first display component includes a display screen; and the display screen is exposed through a first surface of the frame structural body, and the first surface intersects the with side of the frame structural body; and

The electronic device further includes: an information processor configured to obtain by the first sensor a first movement input of a first operating body located on the side of the frame structural body and a second movement input of a second operating body located on the side of the frame structural body; to determine whether the first movement input and the second movement input satisfy a predetermined condition, where the predetermined condition is that a movement direction of the first operating body and a movement direction of the second operating body are consistent with respect to the sensing area; to generate a control instruction when the first movement input and the second movement input satisfy the predetermined condition; and to control a display interface on the display screen in response to the control instruction; and

The first sensor is configured to obtain the first movement input of the first operating body located on the side of the frame structural body and the second movement input of the second operating body located on the side of the frame structural body.

The foregoing electronic device can be a smart watch. The frame structural body can be a dial; and the first display component is a display component installed on the frame structural body, and the display component can include the display screen of the smart watch.

When the frame structural body is a polygon, e.g., a rectangle, the sensing area is located on respective edges of the frame structural body, e.g., four edges of the rectangle; and when the frame structural body is a circle, the sensing area is located on the side of the frame structural body.

Preferably the first movement input of the first operating body located on the side of the frame structural body and the second movement input of the second operating body located on the side of the frame structural body can be obtained by the first sensor as follows: a user in need of an operation on the smart watch starts to perform a movement operation by using two fingers respectively at any locations on the side of the frame structural body; where whether a movement operation has been performed by the fingers can be determined by determining that a movement operation has been performed by the fingers if the fingers have moved over a distance above a preset distance threshold.

The information processor is further configured to determine whether both the movement direction of the first operating body and the movement direction of the second operating body are clockwise or time-counterclockwise with respect to the sensing area, for example, as illustrated in FIG. 2, where the user moving the two fingers clockwise respectively on the side of the dial can indicate that they have a consistent movement direction with respect to the sensing area.

The information processor is further configured to determine a first input track corresponding to the first movement input from starting coordinates, track coordinates and ending coordinates corresponding to the first movement input and to determine a second input track corresponding to the second movement input from starting coordinates, track coordinates and ending coordinates corresponding to the second movement input, for example, as illustrated in FIG. 2, where the user moves the two fingers clockwise, and then track coordinates across which the user moves the two fingers are obtained respectively, and input tracks of the two fingers are determined from the track coordinates corresponding to the two fingers.

The information processor is further configured to determine the movement direction of the first movement input in the sensing area from the starting coordinates and the ending coordinates of the first input track and to determine the movement direction of the second movement input in the sensing area from the starting coordinates and the ending coordinates of the second input track, for example, as illustrated in FIG. 2, where a movement track 211 of an index finger 21 of the user is detected, and a first movement direction of the index finger 21 is determined from starting coordinates and ending coordinates of the movement track 211 as from the left to the right, i.e., clockwise; and a movement track 221 of a thumb 22 of the user is detected, and a second movement direction of the thumb 22 is determined from starting coordinates and ending coordinates of the movement track 221 as from the right to the left, i.e., counterclockwise.

The display interface on the display screen can be controlled in response to the control instruction by the smart watch which generates the corresponding control instruction on the operation by the fingers of the user according to a preset rule upon detecting that the operation satisfies the predetermined condition.

The first control instruction can be a first rotation instruction or a second rotation instruction or a third rotation instruction.

The first control instruction and the response thereto will be described below respectively.

The information processor is further configured, when the first control instruction is the first rotation instruction, to rotate the display interface along the first input track and in the movement direction thereof in response to the first rotation instruction, for example, when there is a map displayed in the display interface, the first rotation instruction is obtained, and at this time the smart watch moves the map in the movement direction of the first input track, and it is assumed that the first input track is the movement track 211 of the index finger 21 as illustrated in FIG. 2, the map will be moved rightward along the movement track 211 of the index finger 21; or

The information processor is further configured, when the first control instruction is the first rotation instruction, to rotate the display interface along the second input track and in the movement direction thereof in response to the first rotation instruction, for example, when there is a map displayed in the display interface, the first rotation instruction is obtained, and at this time the smart watch moves the map in the movement direction of the first input track, and it is assumed that the first input track is the movement track 221 of the thumb 22 as illustrated in FIG. 2, the map will be moved leftward along the movement track 221 of the thumb 22.

The information processor is further configured, when the first control instruction is the second rotation instruction, to control a selection box to move along the first input track and in the movement direction thereof to select a first object on the display interface in response to the second rotation instruction, for example, when there is an operation box displayed in the display interface, the operation box can be a cursor for a time-counting operation, and when the second rotation instruction is obtained, the smart watch moves the cursor for a time-counting operation in the movement direction of the first input track and over the movement distance of the first input track until the cursor is moved to a specific scale which is taken as the first object, and it is assumed that the first input track is the movement track 211 of the index finger 21 as illustrated in FIG. 2, the cursor for a time-counting operation will be moved rightward along the movement track 211 of the index finger 21 over a corresponding distance until the cursor is stopped at the location of the first object selected on the display interface; or

The information processor is further configured, when the first control instruction is the second rotation instruction, to control a selection box to move along the second input track and in the movement direction thereof to select a first object on the display interface in response to the second rotation instruction, for example, when there is an operation box displayed in the display interface, the operation box can be a cursor for a time-counting operation, and when the second rotation instruction is obtained, the smart watch moves the cursor for a time-counting operation in the movement direction of the second input track and over the movement distance of the second input track until the cursor is moved to a specific scale which is taken as the first object, and it is assumed that the second input track is the movement track 211 of the index finger 21 as illustrated in FIG. 2, the cursor for a time-counting operation will be moved rightward along the movement track 211 of the index finger 21 over a corresponding distance until the cursor is stopped at the location of the first object selected on the display interface

The electronic device further includes a second sensor configured to detect a third operation; and correspondingly the information processor is further configured, when the control instruction is the third rotation instruction, to select a second object on the display interface in response to the third operation; and to change the location of the second object along the first input track and in the movement direction thereof in response to the third rotation instruction.

Where the second sensor can be installed above the display screen of the electronic device, for example, when the user performing a time-counting operation needs to select a specific scale using a cursor, the user can firstly adjust the cursor to the scale and then touch the second sensor using his or her middle finger, and the second sensor takes the touch operation as the third operation and determine from the third operation that the user has selected the time scale; and then change both the cursor and its selected time scale along the first input track and in the movement direction thereof or change both the cursor and its selected time scale along the second input track and in the movement direction thereof in response to the third rotation instruction.

Furthermore the information processor is further configured, after the determining whether the first movement direction and the second movement direction are consistent with respect to the sensing area, when the first movement direction and the second movement direction are not consistent with respect to the sensing area, to determine the control instruction as a second control instruction, where when the first movement direction and the second movement direction are not consistent, it may be that both of the two fingers are moved to the center of the watch, and at this time the first movement direction and the second movement direction are not consistent with respect to the sensing area.

The second control instruction can be a closing instruction to close an interface of a current application; or can be a back-to-home-interface instruction to go from an interface of a current application back to a home interface, where the closing instruction is to close the interface displayed by the current application, and an interface at the next higher level can be displayed after the interface is closed.

For example, when the user having finished the foregoing time-counting operation wants to close the operation, the user can move the two fingers to the center of the dial, as illustrated in FIG. 4, and at this time the user can be returned to an operation interface at the next higher level or directly to a home interface.

As can be apparent, with the foregoing solution, the user can perform selection, time-counting and other control on the electronic device without operating on the operation interface of the electronic device, and as such it is possible to avoid or reduce an improper operation from occurring due to the overly small screen of the electronic device and to improve the operation efficiency of the user while guaranteeing an experience of use by the user.

In the several embodiments according to this application, it shall be appreciated that the disclosed devices and methods can be embodied in other ways. The foregoing embodiments of the devices are merely schematic, for example, the division of the devices into the units is merely a logical functional division, and another division is also possible in a practical implementation, for example, a plurality of units or components can be combined or can be integrated into another system, or some features can be omitted or skipped. Moreover, coupling or direct coupling or communication connection between the respective components as illustrated or described can be indirect coupling or communication connection via some interface, device or unit and can be in an electrical, mechanical or another form.

The units described as separate components may or may not be physically separated, and the components illustrated as units may or may not be physical units, that is, they can be co-located or can be distributed to a plurality of network elements; and some or all of the units can be selected as needed in practice for the purpose of the solution according to the present embodiment.

Moreover, the respective functional units in the respective embodiments of the invention can all be integrated into one processing module, or each of the respective units can be arranged separately as a single unit, or two or more of the foregoing units can be integrated into one unit; and the foregoing integrated units can be embodied in the form of hardware or can be embodied in the form of hardware plus software functional units.

Those ordinarily skilled in the art can appreciate that all or a part of the steps in the embodiments of the methods can be performed by a piece of program instructing a relevant item of hardware, and the foregoing program can be stored in a computer readable storage medium, and the program upon being executed can perform the steps of the foregoing embodiments of the method; and the foregoing storage medium can include a mobile storage device, a Read-Only Memory (ROM), a Random Access Memory (RAM), a magnetic disk, an optical disk and various mediums capable of storing program codes.

The foregoing description is merely illustrative of particular embodiments of the invention, but the scope of the invention will not be limited thereto, and any variations or substitutions that will readily occur to those skilled in the art without departing from the scope of the inventive discourse shall come into the scope of the invention. Accordingly the scope of the invention shall be as defined in the appended claims.

1. An information processing method, applied to an electronic device including a frame structural body, a first display component and a first sensor, and the frame structural body includes a fixing structure capable of fixing the electronic device on an object; the first display component is fixed on the frame structural body, and the first display component includes a display screen; and the display screen is exposed through a first surface of the frame structural body, the first sensor is arranged inside the frame structural body, a sensing area of the first sensor is located on a side of the frame structural body, and the first surface intersects with the side, wherein the method comprises:
by the first sensor, obtaining a first movement input of a first operating body located on the side of the frame structural body and a second movement input of a second operating body located on the side of the frame structural body;
determining whether the first movement input and the second movement input satisfy a predetermined condition, wherein the predetermined condition is that a movement direction of the first operating body and a movement direction of the second operating body are consistent with respect to the sensing area;
generating a control instruction when the first movement input and the second movement input satisfy the predetermined condition; and
controlling a display interface on the display screen in response to the control instruction.

2. The method according to claim 1, wherein the determining whether the first movement input and the second movement input satisfy a predetermined condition comprises:
obtaining a first input track of the first movement input, and obtaining a second input track of the second movement input;
determining a first movement direction of the first movement input in the sensing area from the first input track, and determining a second movement direction of the second movement input in the sensing area from the second input track;
determining whether the first movement direction and the second movement direction are consistent with respect to the sensing area; and
when the first movement direction and the second movement direction are consistent with respect to the sensing area, determining that the first movement input and the second movement input satisfy a predetermined condition, and determining the control instruction as a first control instruction.

3. The method according to claim 2, wherein:
the first control instruction is a first rotation instruction; and
the controlling a display interface on the display screen in response to the control instruction comprises: rotating the display interface along the first input track and in the movement direction thereof in response to the first rotation instruction.

4. The method according to claim 2, wherein
the first control instruction is a second rotation instruction; and
the controlling a display interface on the display screen in response to the control instruction comprises: controlling a selection box to move along the first input track and in the movement direction thereof to select a first object on the display interface in response to the second rotation instruction.

5. The method according to claim 2, wherein:
the control instruction is a third rotation instruction; and
the controlling a display interface on the display screen in response to the control instruction comprises: detecting by a second sensor a third operation and selecting a second object on the display interface in response to the third operation; and
changing the location of the second object along the first input track and in the movement direction thereof in response to the third rotation instruction.

6. The method according to claim 2, wherein after the determining whether the first movement direction and the second movement direction are consistent with respect to the sensing area, the method further comprises:
when the first movement direction and the second movement direction are not consistent with respect to the sensing area, determining the control instruction as a second control instruction.

7. The method according to claim 6, wherein the second control instruction is a closing instruction to close an interface of a current application.

8. The method according to claim 6, wherein the second control instruction is a back-to-home-interface instruction to go from an interface of a current application back to a home interface.

9. An electronic device, comprising a first display component and a first sensor, wherein:
the first sensor is arranged inside a frame structural body, and the frame structural body includes a fixing structure capable of fixing the electronic device on an object; and a sensing area of the first sensor is located on a side of the frame structural body;
the first display component is fixed on the frame structural body, and the first display component includes a display screen; and the display screen is exposed through a first surface of the frame structural body, and the first surface intersects the side of the frame structural body; and
the electronic device further comprises: an information processor configured to obtain by the first sensor a first movement input of a first operating body located on the side of the frame structural body and a second movement input of a second operating body located on the side of the frame structural body; to determine whether the first movement input and the second movement input satisfy a predetermined condition, wherein the predetermined condition is that a movement direction of the first operating body and a movement direction of the second operating body are consistent with respect to the sensing area; to generate a control instruction when the first movement input and the second movement input satisfy the predetermined condition; and to control a display interface on the display screen in response to the control instruction; and
the first sensor is configured to obtain the first movement input of the first operating body located on the side of the frame structural body and the second movement input of the second operating body located on the side of the frame structural body.

10. The electronic device according to claim 9, wherein:
the information processor is further configured to obtain a first input track of the first movement input, and to obtain a second input track of the second movement input; to determine a first movement direction of the first movement input in the sensing area from the first input track, and to determine a second movement direction of the second movement input in the sensing area from the second input track; and to determine whether the first movement direction and the second movement direction are consistent with respect to the sensing area, and when the first movement direction and the second movement direction are consistent with respect to the sensing area, to determine that the first movement input and the second movement input satisfy a predetermined condition, and to determine the control instruction as a first control instruction.

11. The electronic device according to claim 10, wherein:
the information processor is further configured, when the first control instruction is a first rotation instruction, to rotate the display interface along the first input track and in the movement direction thereof in response to the first rotation instruction.

12. The electronic device according to claim 10, wherein:
the information processor is further configured, when the first control instruction is a second rotation instruction, to control a selection box to move along the first input track and in the movement direction thereof to select a first object on the display interface in response to the second rotation instruction.

13. The electronic device according to claim 10, wherein the electronic device further comprises a second sensor configured to detect a third operation; and
Correspondingly, the information processor is further configured, when the control instruction is a third rotation instruction, to select a second object on the display interface in response to the third operation; and to change the location of the second object along the first input track and in the movement direction thereof in response to the third rotation instruction.

14. The electronic device according to claim 10, wherein:
the information processor is further configured, after determining whether the first movement direction and the second movement direction are consistent with respect to the sensing area, when the first movement direction and the second movement direction are not consistent with respect to the sensing area, to determine the control instruction as a second control instruction.

15. The electronic device according to claim 14, wherein the second control instruction is a closing instruction to close an interface of a current application.

16. The electronic device according to claim 14, wherein the second control instruction is a back-to-home-interface instruction to go from an interface of a current application back to a home interface.
